(19) United States
(12) Patent Application Publication
(10) Pub. No.: US 2026/0058414 A1
(43) Pub. Date: Feb. 26, 2026

(54) Connector Assembly

(71) Applicant: Tyco Electronics AMP Korea Co., Ltd., Gyeongsan (KR)

(72) Inventors: Jung Myoung Park, Gyeongsan-si (KR); Hyun Sang Park, Gyeongsan-Si (KR)

(73) Assignee: Tyco Electronics AMP Korea Co., Ltd., Gyeongsan (KR)

(21) Appl. No.: 19/310,419

(22) Filed: Aug. 26, 2025

(30) Foreign Application Priority Data
Aug. 26, 2024 (KR) 10-2024-0114287
Jul. 25, 2025 (KR) 10-2025-0101313

(51) Int. Cl. H01R 13/6581; H01R 13/52

(52) U.S. Cl. CPC H01R 13/6581; H01R 13/5219; H01R 2201/26

(57) ABSTRACT

A connector assembly inserted into a counterpart device includes an inner housing, a shield housing, an outer housing, and a connector seal. The inner housing has a terminal hole and is formed of a non-conductive material. The shield housing has a height lower than a height of the inner housing, surrounds a side surface of the inner housing, and is formed of a conductive material. The outer housing has an outer flange and an outer body. The outer body has a height lower than the height of the shield housing so that at least a portion of the shield housing is exposed to an outside and surrounds a side surface of the shield housing. The outer flange extends outward from the outer body. The connector seal is disposed on an opposite side of the outer body and surrounds the side surface of the inner housing.

### CROSS-REFERENCE TO RELATED APPLICATIONS

This application claims the benefit of the filing date under 35 U.S.C. § 119 (a)-(d) of Korean Patent Application No. 10-2024-0114287, filed on Aug. 26, 2024, and Korean Patent Application No. 10-2025-0101313, filed on Jul. 25, 2025, the entire disclosures of which are incorporated herein by reference.

### FIELD OF THE INVENTION

The present invention relates to an assembly and, more particularly, to a connector assembly.

### BACKGROUND OF THE INVENTION

A connector is a type of component that selectively connects or disconnects an electrical connection. Typically, many electrical components, such as electronic components or sensors, are installed in vehicles, and these electrical components are electrically connected to other electrical components or power sources through cables and connectors. For cables or connectors, through which a high voltage and/or high current that may cause electric shock to a person flows, a shield may be provided to prevent the electric shock or noise.

For example, when two electrical components are connected to each other through a connector, there is a risk that electromagnetic waves generated from the electrical components may leak through the connector, causing interference with nearby electrical components and causing malfunctions. Such malfunctions may result in device breakdown. Also, external electromagnetic noise may cause an abnormal operation of the electrical components.

To prevent the electric shock or noise, metal connectors may be manufactured using precision casting methods such as die casting. However, when the entire connector is manufactured from metal, the cost may be excessive. Therefore, in order to reduce the cost for manufacturing the connector, there is a need for a structure in which a connector body is formed of a plastic material, while using a shield to prevent the electric shock or noise.

### SUMMARY OF THE INVENTION

A connector assembly inserted into a counterpart device includes an inner housing, a shield housing, an outer housing, and a connector seal. The inner housing has a terminal hole and is formed of a non-conductive material. The shield housing has a height lower than a height of the inner housing, surrounds a side surface of the inner housing, and is formed of a conductive material. The outer housing has an outer flange and an outer body. The outer body has a height lower than the height of the shield housing so that at least a portion of the shield housing is exposed to an outside and surrounds a side surface of the shield housing. The outer flange extends outward from the outer body. The connector seal is disposed on an opposite side of the outer body and surrounds the side surface of the inner housing.

### BRIEF DESCRIPTION OF DRAWINGS

The invention will now be described by way of example with reference to the accompanying figures, of which:

FIG. 1 is a top view of a connector assembly according to an embodiment fastened to a counterpart device;

FIG. 2 is a front view of the connector assembly of FIG. 1 fastened to the counterpart device of FIG. 1, when viewed from a device side;

FIG. 3 is a perspective view of the connector assembly of FIG. 1;

FIG. 4 is an exploded perspective view of the connector assembly of FIG. 1;

FIG. 5 is a perspective view of an inner housing of the connector assembly of FIG. 1 according to an embodiment;

FIG. 6 is a perspective view of a shield housing of the connector assembly of FIG. 1 according to an embodiment;

FIG. 7 is a perspective view of an outer housing of the connector assembly of FIG. 1 according to an embodiment;

FIG. 8 is a cross-sectional view of the connector assembly of FIG. 1 fastened to the counterpart device of FIG. 1;

FIG. 9 is an enlarged view of a portion P1 of FIG. 8;

FIG. 10 is an enlarged view of a portion P2 of FIG. 8;

FIG. 11 is a perspective view of a cable assembly of the connector assembly of FIG. 1 according to an embodiment;

FIG. 12 is a perspective view of a cable support structure of the cable assembly of FIG. 11 according to an embodiment;

FIG. 13 is a cross-sectional view of the cable assembly of FIG. 11 coupled to an inner portion of the inner housing of FIG. 5;

FIG. 14 is an enlarged view of the cable assembly of FIG. 11 inserted into a cable insertion groove of the connector assembly of FIG. 1; and

FIG. 15 is an enlarged view of a portion P3 of FIG. 8.

### DETAILED DESCRIPTION

Hereinafter, embodiments will be described in detail with reference to the accompanying drawings. However, various alterations and modifications may be made to the embodiments. Here, the embodiments are not construed as limited to the disclosure. The embodiments should be understood to include all changes, equivalents, and replacements within the idea and the technical scope of the disclosure.

The terminology used herein is for the purpose of describing a particular embodiment only and is not to be limiting of the embodiment. As used herein, the singular form is intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

As used herein, “A or B,” “at least one of A and B,” “at least one of A or B,” “A, B or C,” “at least one of A, B and C,” and “at least one of A, B, or C,” each of which may include any one of the items listed together in the corresponding one of the phrases, or all possible combinations thereof.

Unless otherwise defined, all terms including technical and scientific terms used herein have the same meaning as commonly understood by one of ordinary skill in the art to which the embodiments belong. Terms, such as those defined in commonly used dictionaries, are to be interpreted as having a meaning that is consistent with their meaning in the context of the relevant art and the present disclosure, and are not to be interpreted in an idealized or overly formal sense unless expressly so defined herein.

When describing the embodiments with reference to the accompanying drawings, the same or similar elements are denoted by the same reference numerals even though they are depicted in different drawings, and redundant descriptions thereof will be omitted. In the description of embodiments, detailed description of well-known related structures or functions will be omitted when it is deemed that such description will cause ambiguous interpretation of the present disclosure.

Also, in the description of the components, terms such as first, second, A, B, (a), (b) or the like may be used herein when describing components of the present disclosure. These terms are used only for the purpose of discriminating one component from another component, and the nature, the sequences, or the orders of the components are not limited by the terms. When one component is described as being “connected,” “coupled,” or “attached” to another component, it should be understood that one component may be connected or attached directly to another component, and an intervening component may also be “connected,” “coupled,” or “attached” to the components.

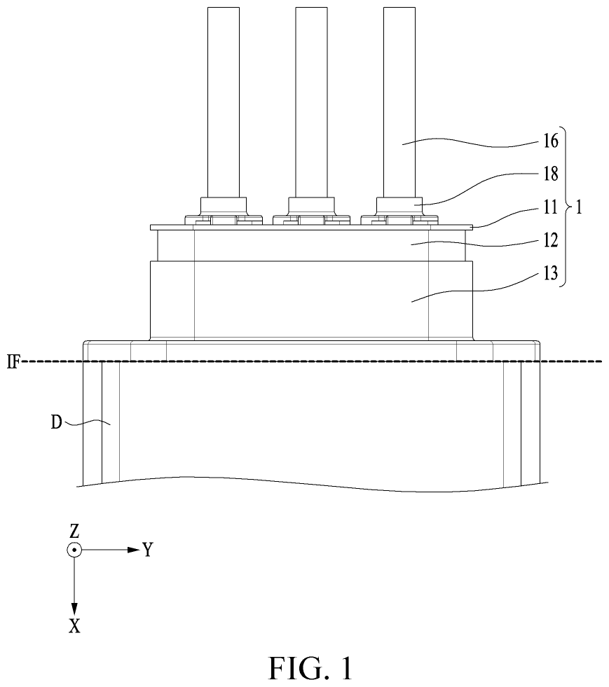

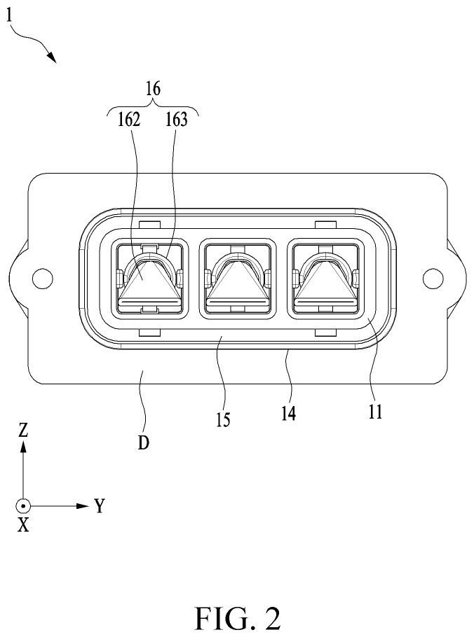

A connector assembly 1 will now be described with reference to FIGS. 1-15. As shown in FIGS. 1-2, the connector assembly 1 according to an embodiment may be inserted into a counterpart device D (e.g., a vehicle device). In a state where the connector assembly 1 is properly fastened to the counterpart device D, one surface of the connector assembly 1 (e.g., one surface of an outer flange 132) may be in surface contact with a surface of the counterpart device D. A boundary where the connector assembly 1 and the counterpart device D are in surface contact with each other may be referred to as a contact interface IF. A portion of the connector assembly 1 (e.g., a portion of an inner housing 11 that protrudes toward the counterpart device D) based on the contact interface IF may be inserted into the counterpart device D.

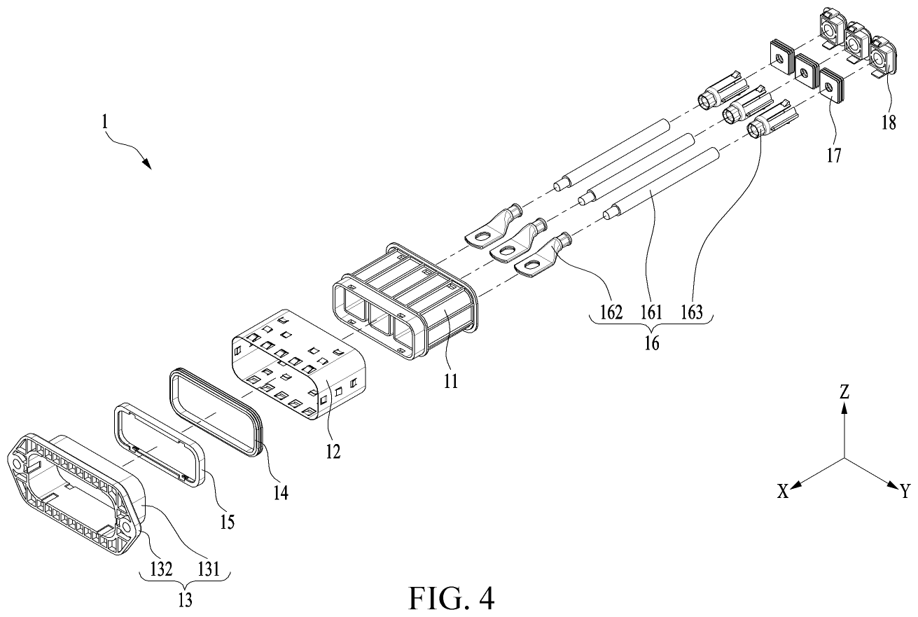

As shown in FIG. 4, the connector assembly 1 may include the inner housing 11, a shield housing 12, an outer housing 13, a connector seal 14, a seal retainer 15, a cable assembly 16, a cable seal 17, and a cable cover 18. For example, the inner housing 11, the shield housing 12, and the outer housing 13 may be formed as separate members and then may be coupled to each other. According to this structure, even when the inner housing 11 and the outer housing 13 are formed of a non-conductive material (e.g., a plastic material), the shield housing 12 may be formed of a conductive material (e.g., a metal) to use the shield housing 12 as a member for grounding the cable assembly 16. For example, parts corresponding to the inner housing 11, the shield housing 12, and the outer housing 13 may be formed as housings with a single conductive material to use the housings as the member for grounding described above. However, when the inner housing 11, the shield housing 12, and the outer housing 13 are formed as three separate members and then coupled to each other as in the embodiment described above, only some of the three members (e.g., the shield housing 12) may be formed of a conductive material, and the remaining members (e.g., the inner housing 11 and the outer housing 13) may be formed of a non-conductive material, thereby reducing manufacturing cost of the whole connector assembly 1.

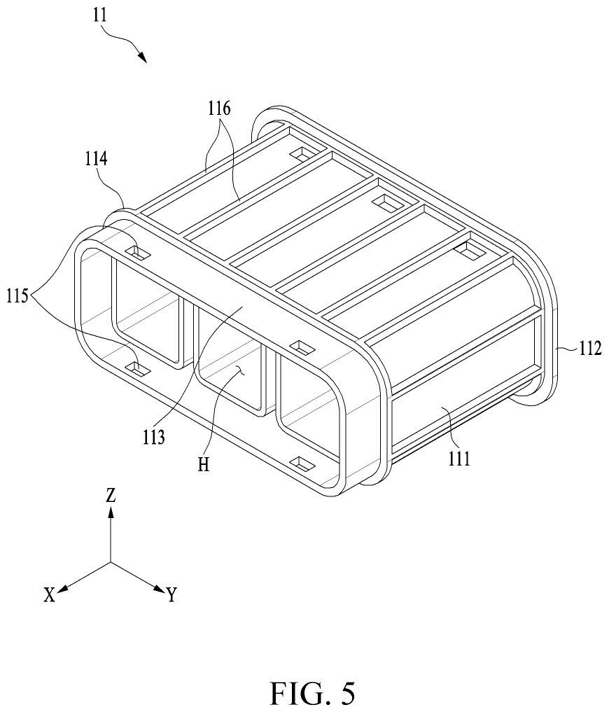

The inner housing 11 may include a terminal hole H, as shown in FIGS. 5 and 13-15, and may be formed of a non-conductive material. The inner housing 11 may be formed of a non-conductive material, thereby reducing a problem of current leakage from the cable assembly 16 through the inner housing 11 or unwanted current introduction from the outside. The cable assembly 16 may be physically and electrically connected to an electronic component of the counterpart device D by passing through the terminal hole H.

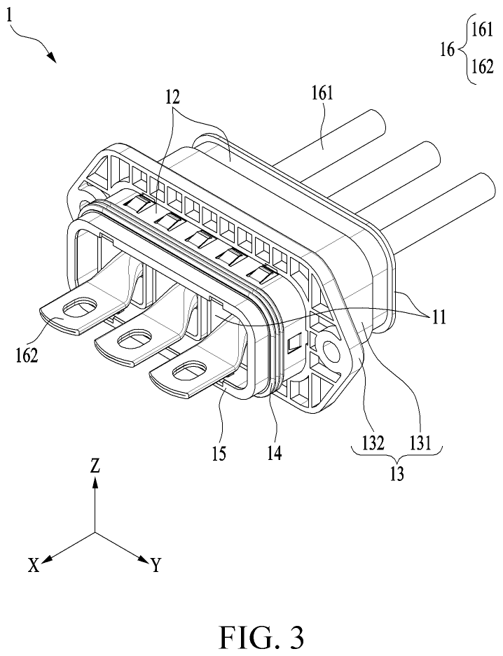

The shield housing 12 may have a height lower than a height of the inner housing 11 (e.g., a length in a direction in which the connector assembly 1 is inserted into the counterpart device D (e.g., an X direction)), may be installed to surround a side surface of the inner housing 11, and may be formed of a conductive material. At least a portion of the shield housing 12 may be exposed to the outside in a space between a shield stopper 112, as shown in FIG. 5, of the inner housing 11 and an outer body 131, as shown in FIG. 3. According to this structure, a portion of the cable assembly 16 may be connected to the shield housing 12 as needed, and thus, the shield housing 12 may function as a ground member.

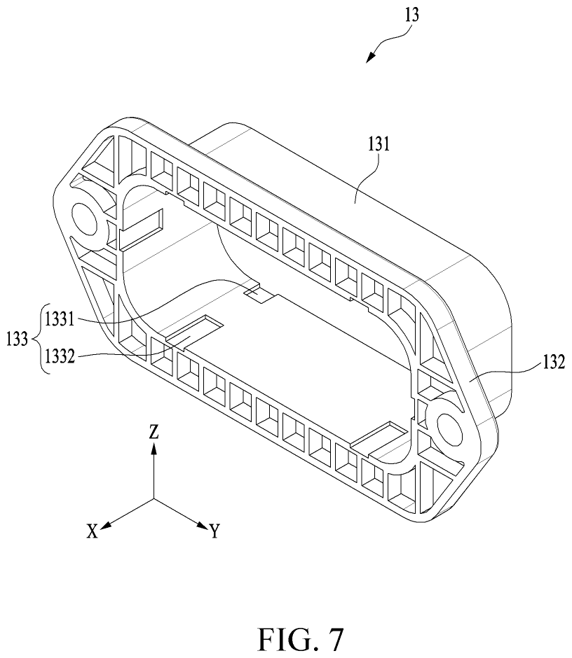

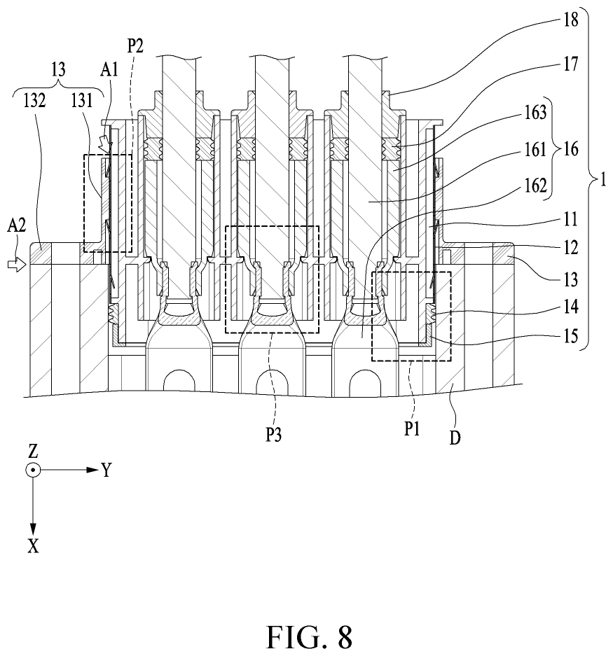

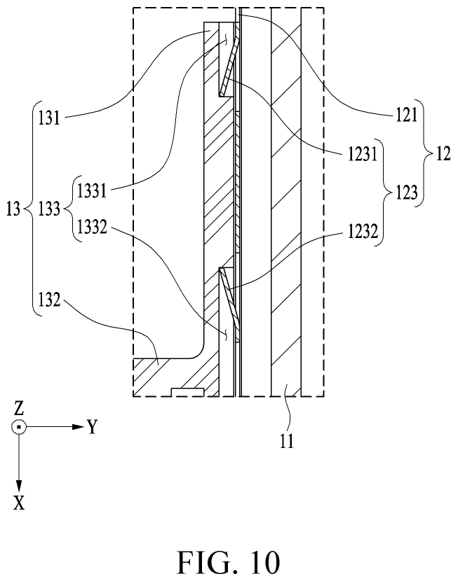

The outer housing 13 may be formed of, for example, a non-conductive material. The outer housing 13 may include the outer body 131, as shown in FIGS. 4 and 7, installed to surround a side surface of the shield housing 12, as shown in FIGS. 8 and 10, and the outer flange 132 extending outward from the outer body 131, as shown in FIGS. 4 and 7.

The outer body 131 may have a height lower than, for example, a height of the shield housing 12 (e.g., the length in the direction (e.g., the X direction) in which the connector assembly 1 is inserted into the counterpart device D). According to such a configuration, by positioning the outer body 131 in a specific area on the shield housing 12, at least a portion of the shield housing 12 may be exposed to the outside. The outer body 131 may have a shape extending from the outer flange 132 toward an opposite side of the counterpart device D.

As shown in FIG. 8, the connector seal 14 may be installed to surround the side surface of the inner housing 11, thereby reducing a problem of foreign materials introduced into an inner space of the counterpart device D from the outside. For example, the connector seal 14 may be disposed on an opposite side (e.g., +X direction side) of the outer body 131 based on the outer flange 132. For example, in a state where the connector assembly 1 is properly fastened to the counterpart device D, as shown in FIG. 1, the connector seal 14 may be positioned inside the counterpart device D. In other words, the connector seal 14 may be disposed at a position spaced apart in an insertion direction (e.g., +X direction), in which the connector assembly 1 is inserted into the counterpart device D, based on the contact interface IF, as shown in FIG. 1. According to such arrangement, as will be described below, with only one connector seal 14, both a problem of foreign materials introduced to the contact interface IF, and a problem of foreign materials introduced between any pair of members among the inner housing 11, the shield housing 12, and the outer housing 13, may be reduced.

As shown in FIG. 8, the seal retainer 15 may be positioned on an opposite side (e.g., +X direction side) of the shield housing 12 based on the connector seal 14, and may prevent the connector seal 14 from being separated from the inner housing 11. The seal retainer 15, as shown in FIG. 4, may have a donut shape that includes a hole formed inside to allow the cable assembly 16 to pass through. For example, the seal retainer 15 may be formed as a separate member from the inner housing 11 and may be fastened to a fastening structure for the retainer 115 of the inner housing 11, as shown in FIG. 5. However, this is merely an example, and it should be noted that the seal retainer 15 may be formed integrally with the inner housing 11.

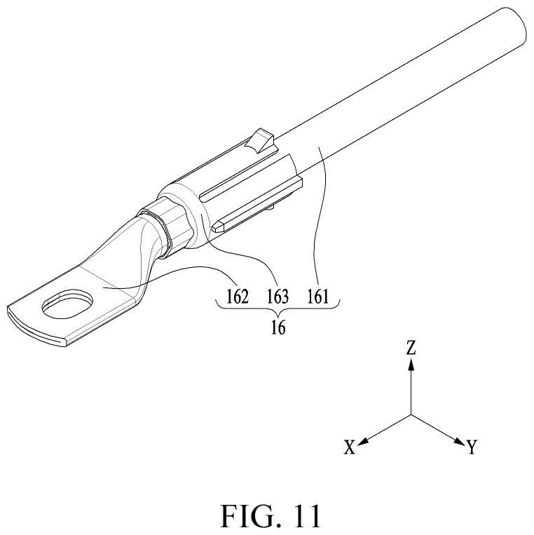

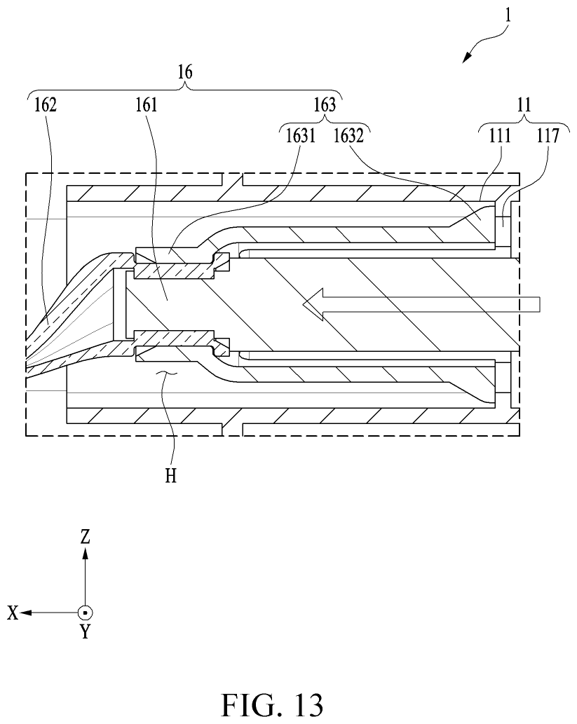

As shown in FIGS. 13-15, the cable assembly 16 may be inserted into the terminal hole H. The cable assembly 16 may include, as shown in FIGS. 11, 13, and 15, a connecting cable 161 including a conductive wire and transmitting power and/or a signal, a cable terminal 162, and a cable support structure 163. The cable terminal 162 may be connected to an end portion of the connecting cable 161. The cable terminal 162 may be connected to the connecting cable 161 by, for example, pressing or soldering using a conductive material. According to the cable terminal 162, the case of a wiring task with the counterpart device D may be improved. The cable terminal 162 may include, for example, a lug terminal. The cable support structure 163 may support the cable terminal 162 from an inner wall of the terminal hole H. For example, the cable support structure 163 may interfere with the inner wall of the terminal hole H to ensure that the cable terminal 162 is positioned in a predetermined area within the terminal hole H and/or maintains a predetermined angle. An exemplary structure for the cable support structure 163 will be described below.

As shown in FIG. 8, the cable seal 17 may be positioned between the inner housing 11 and the cable cover 18, and may reduce the problem of foreign materials introduced to the terminal hole H from the outside. As shown in FIG. 4, the cable seal 17 may include a hole through which the connecting cable 161 may pass. For example, the cable seal 17 may be provided in plurality corresponding to the number of terminal holes H, but the cable seal 17 is not limited thereto.

As shown in FIG. 8, the cable cover 18 may cover a rear side of the inner housing 11 (e.g., an opposite direction of the counterpart device D). The cable cover 18 may include, as shown in FIG. 4, a fastening structure fastened to the inner housing 11, such as a hook protrusion and/or a hook groove, and may be fastened to the rear side of the inner housing 11, thereby preventing the cable seal 17 from being removed from the inner housing 11.

As shown in FIG. 5, the inner housing 11 according to an embodiment may include an inner body 111 through which a terminal hole H is formed, the shield stopper 112, a seal mounting surface 113, a seal stopper 114, the fastening structure for the retainer 115, and an inner rib 116.

The shield stopper 112, as shown in FIG. 5, may protrude outward from the inner body 111 and may support the shield housing 12. The shield stopper 112 may have a flange shape that protrudes outward from an end portion of the inner body 111 (e.g., an opposite end portion of the counterpart device D). The shield stopper 112 may support one side of two sides of the shield housing 12 (e.g., a side opposite to the direction in which the connector assembly 1 is inserted into the counterpart device D, the −X direction side), and the connector seal 14 may be positioned on the other side of the two sides of the shield housing 12 (e.g., the +X direction side). The connector seal 14 may be supported so as not to be removed by the seal retainer 15. As a result, the two sides of the shield housing 12 may be positioned in a specific area on the inner housing 11 by the shield stopper 112, the connector seal 14, and the seal retainer 15.

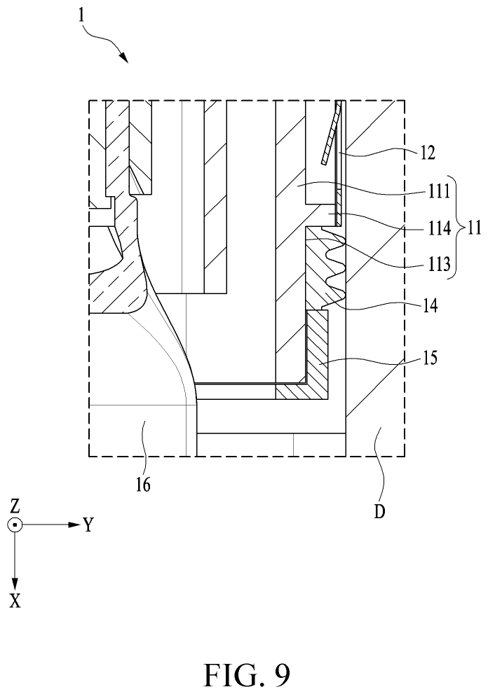

As shown in FIG. 9, the connector seal 14 may be mounted on the seal mounting surface 113. It may be understood that the seal mounting surface 113 refers to a portion of the inner housing 11 extending toward the counterpart device D. When the connector assembly 1 is properly fastened to the counterpart device D, the seal mounting surface 113 may be inserted into the counterpart device D and face an inner wall of the counterpart device D. Based on the assembled state of the connector assembly 1, the seal mounting surface 113 may have a shape that extends toward the inside of the counterpart device D more than the shield housing 12. In order to provide a sufficient space for the connector seal 14 to be mounted, the seal mounting surface 113 may be sufficiently elongated. When the seal stopper 114 is provided in the inner housing 11, the seal mounting surface 113 may be understood as a portion of the inner housing 11 extending to an opposite side of the shield stopper 112 based on the seal stopper 114.

The seal stopper 114 may limit the position at which the connector seal 14 is inserted into the inner housing 11. For example, the seal stopper 114, as shown in FIG. 5, may have a flange shape that protrudes outward from the inner body 111. According to the seal stopper 114, the problem of the connector seal 14 being damaged by a sharp end portion of the seal stopper 114 may be reduced by reducing the problem of the connector seal 14 directly coming into contact with the shield housing 12.

As shown in FIG. 5, one or more (e.g., a plurality of) fastening structures for the retainer 115 may be formed on one side of the seal mounting surface 113. The fastening structure for the retainer 115 may have a structure that engages with a fastening structure formed in the seal retainer 15, such as a hook protrusion and/or a hook groove. However, as described above, when the seal retainer 15 is formed integrally with the inner housing 11, the fastening structure for the retainer 115 may be omitted.

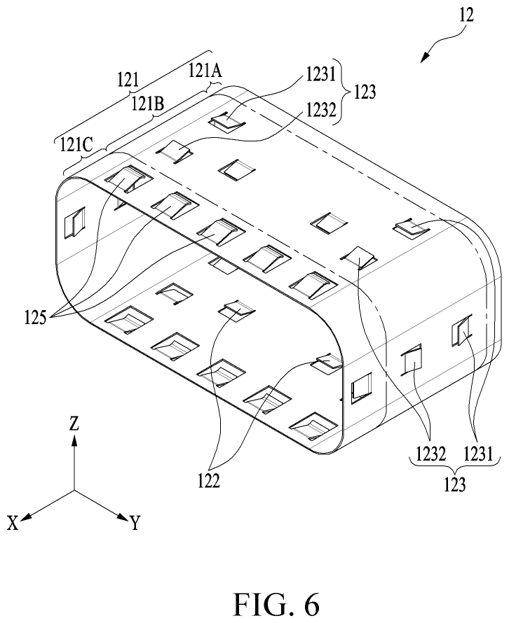

The inner rib 116 may reinforce the stiffness of the inner housing 11 by protruding, as shown in FIG. 5, to a side surface of the inner body 111. The inner rib 116 may be connected to the shield stopper 112 and/or the seal stopper 114, for example, by being elongated in a height direction (e.g., the X direction) of the inner housing 11. According to such a structure, by reducing a volume of the inner housing 11, material cost of the inner housing 11 may be saved, while also reducing the problem of the reduction of the stiffness of the inner housing 11. However, it should be noted that a direction of the formation of the inner rib 116 is not necessarily limited thereto. For example, the inner rib 116 may support the shield housing 12. For example, a protrusion height of the inner rib 116 may correspond to a distance between an inner wall of the shield housing 12 and an outer surface of the inner body 111. According to such a structure, as the shield housing 12 is deformed, the problem of a fixing protrusion 123 for the outer housing 13, as shown in FIG. 6, of the shield housing 12 being removed from the outer housing 13 may be reduced.

As shown in FIG. 6, the shield housing 12 according to an embodiment may include a shield body 121 installed to surround the side surface of the inner housing 11, a support protrusion 122 for the inner housing 11, the fixing protrusion 123 for the outer housing 13, and a support protrusion for the device 125.

As shown in FIG. 6, the shield body 121 may include a ground part 121A exposed to the outside based on a state in which the connector assembly 1 is inserted into the counterpart device D (see FIGS. 1 and 3), a coupling part 121B formed with a structure that engages with the outer housing 13, and an insertion part 121C inserted into the counterpart device D.

The support protrusion 122 for the inner housing 11, as shown in FIG. 6, may be formed to protrude inward from the shield body 121 to support the side surface of the inner housing 11. For example, a protrusion height of the support protrusion 122 for the inner housing 11 may correspond to the distance between the inner wall of the shield housing 12 and the outer surface of the inner body 111. According to such a structure, as the shield housing 12 is deformed, the problem of the fixing protrusion 123 for the outer housing 13 of the shield housing 12 being removed from the outer housing 13 may be reduced.

The fixing protrusion 123 for the outer housing 13, as shown in FIG. 6, may fix the outer body 131 to a specific position on the shield body 121, thereby allowing at least a portion of the shield body 121 (e.g., the ground part 121A) to be exposed to the outside. The fixing protrusion 123 for the outer housing 13 may include a spacing-maintaining protrusion 1231 and a removal prevention protrusion 1232, as shown in FIGS. 6 and 10.

As shown in FIG. 6, the spacing-maintaining protrusion 1231 may protrude to be inclined from a side surface of the shield body 121 in a direction toward the connector seal 14 (e.g., the −X direction) as going outward. As shown in FIG. 10, the spacing-maintaining protrusion 1231 may engage with the outer housing 13 (e.g., a spacing-maintaining groove 1331) to limit an insertion length of the outer housing 13 in one direction (e.g., the −X direction), thereby allowing the ground part 121A of the shield body 121 to be exposed to the outside.

As shown in FIG. 6, the removal prevention protrusion 1232 may protrude to be inclined from the side surface of the shield body 121 toward an opposite side of the connector seal 14 as going outward. For example, the removal prevention protrusion 1232 may be positioned closer to the connector seal 14 than the spacing-maintaining protrusion 1231. As shown in FIG. 10, the removal prevention protrusion 1232 may engage with the outer housing 13 (e.g., a removal prevention groove 1332) to prevent the outer housing 13 from being removed in the other direction (e.g., the +X direction) in a state where the outer housing 13 is properly coupled to the shield housing 12.

As shown in FIG. 6, the support protrusion for the device 125 may be formed to protrude from the insertion part 121C. The support protrusion for the device 125 may be provided to be elastically deformable to come into elastic contact with an inner surface of the counterpart device D. For example, the support protrusion for the device 125 may be positioned between the connector seal 14 and the outer flange 132. According to the support protrusion for the device 125, the connector assembly 1 may be maintained in contact with the counterpart device D, so that structural stability may be improved. In addition, the support protrusion for the device 125 may improve a shielding function by coming into contact with a portion of the conductive material of the counterpart device D.

For example, the support protrusion 122 for the inner housing 11, the spacing-maintaining protrusion 1231, and/or the removal prevention protrusion 1232 described above may be formed by cutting and bending a portion of the inner body 111 formed of a plate of a thin conductive material (e.g., metal), but are not limited thereto.

As shown in FIG. 7, the outer housing 13 according to an embodiment may include the outer body 131, the outer flange 132, and a fixing groove for shield 133. The fixing groove for shield 133 may be recessed on an inner surface of the outer body 131 and may engage with the fixing protrusion 123 for the outer housing 13 of the shield housing 12. The fixing groove for shield 133 may include the spacing-maintaining groove 1331 and the removal prevention groove 1332.

As shown in FIG. 7, the spacing-maintaining groove 1331 may be formed to extend in a height direction (e.g., the X direction) of the outer body 131 from an end portion positioned on the opposite side of the connector seal 14, among the inner surface of the outer body 131. The spacing-maintaining groove 1331 may limit the insertion length of the outer housing 13 in one direction (e.g., the −X direction) together with the spacing-maintaining protrusion 1231, thereby allowing the ground part 121A of the shield body 121 to be exposed to the outside.

As shown in FIG. 7, the removal prevention groove 1332 may be formed to extend in the height direction (e.g., the X direction) of the outer body 131 from an end portion positioned close to the connector seal 14, among the inner surface of the outer body 131. For example, the removal prevention groove 1332 may be positioned closer to the connector seal 14 than the spacing-maintaining groove 1331. The removal prevention groove 1332 may prevent the outer housing 13 from being removed in the other direction (e.g., the +X direction) in a state where the outer housing 13 is properly fastened to the shield housing 12 together with the removal prevention protrusion 1232.

As shown in FIGS. 8-9, the connector seal 14 may seal between an inner wall of the counterpart device D and an outer wall of the inner housing 11. According to such a structure, the problem of foreign materials introducing into the inside of the counterpart device D from the outside may be reduced in a state where the connector assembly 1 is properly fastened to the counterpart device D.

For example, when the inner housing 11, the shield housing 12, and the outer housing 13 are formed as separate members and then assembled, there is a possibility of the introduction of foreign materials to a space between the inner housing 11 and the shield housing 12 and/or between the shield housing 12 and the outer housing 13, as shown by a first arrow A1 shown in FIG. 8. However, even if foreign materials are introduced in this way, the problem of foreign materials being introduced into a space between the inner wall of the counterpart device D and the outer wall of the inner housing 11 may be reduced by the connector seal 14.

In another example, there is a possibility that foreign materials are introduced through the contact interface IF where the connector assembly 1 contacts the counterpart device D, as shown by a second arrow A2 shown in FIG. 8. However, even if foreign materials are introduced in this way, the problem of foreign materials being introduced into the space between the inner wall of the counterpart device D and the outer wall of the inner housing 11 may be reduced by the connector seal 14.

In other words, by installing the connector seal 14 to surround the circumference of a portion (e.g., the inner housing 11) that is inserted into the inside of the counterpart device D among the connector assembly 1, rather than on the contact interface IF, the problem of foreign materials introduced in a plurality of directions may be reduced by only one connector scal 14.

As shown in FIGS. 9 and 13-15, the inner housing 11 according to an embodiment may include the inner body 111, and portions (e.g., a hook protrusion for a cable 117, a guide for the cable 118, and/or a cable stopper 119) that prevents the cable support structure 163 from moving and rotating within the terminal hole H. The hook protrusion for the cable 117, the guide for the cable 118, and the cable stopper 119 may each be formed to protrude from an inner wall of the terminal hole H.

The cable support structure 163, as shown in FIGS. 11-15, according to an embodiment may include a support body 1631 fixed to the cable terminal 162, a hook lance 1632 formed to extend from the support body 1631, and a slider 1633 formed to protrude outward from the support body 1631.

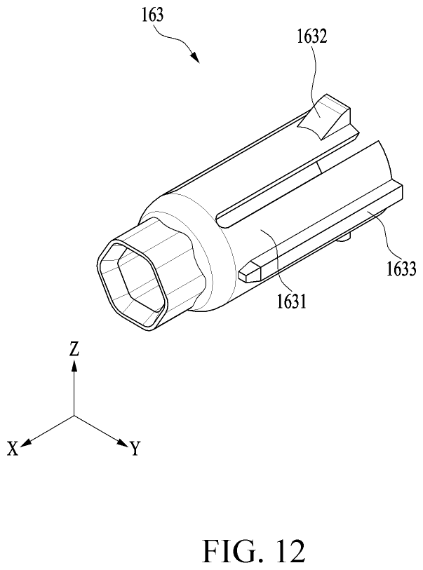

As shown in FIG. 12, the hook lance 1632 may have a cantilever shape that extends from the support body 1631 and is elastically deformable. The hook lance 1632 may be hooked on the hook protrusion for the cable 117 to prevent the cable assembly 16 from being withdrawn, in a state where the cable assembly 16 is properly inserted into the terminal hole H, as shown in FIG. 13.

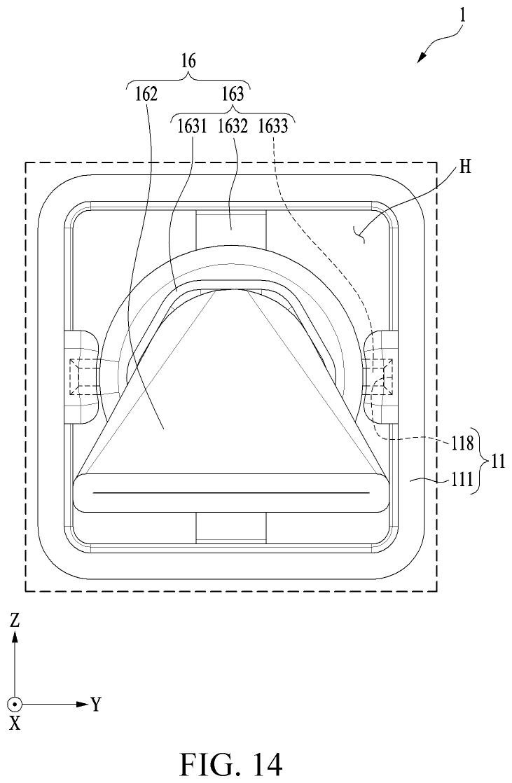

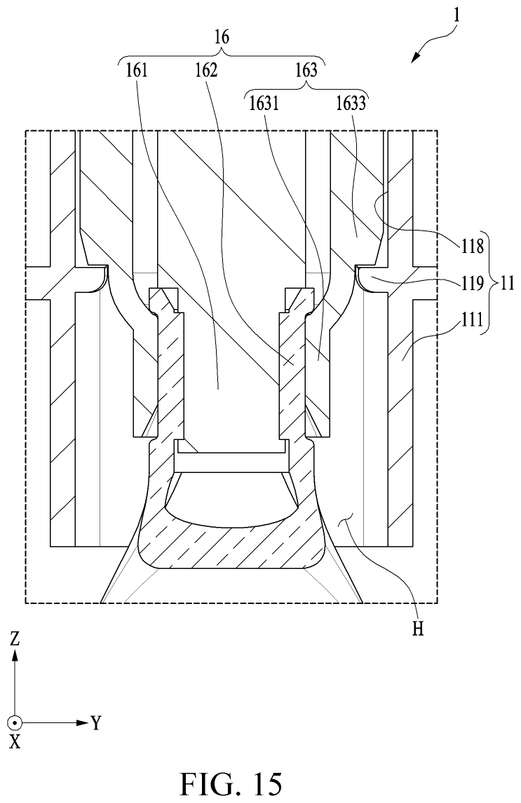

As shown in FIGS. 14-15, the guide for the cable 118 may be formed on the inner wall of the terminal hole H along a longitudinal direction of the terminal hole H (e.g., the X direction). According to the guide for the cable 118, during a process in which the cable assembly 16 is inserted into the terminal hole H, the cable support structure 163 (e.g., the slider 1633) may slide along the guide for the cable 118.

The cable stopper 119, as shown in FIG. 15, may limit a length of the cable terminal 162 inserted into the terminal hole H by interfering with the cable terminal 162.

Based on a state in which the connector assembly 1 is properly fastened to the inner housing 11, a movement distance of the connector assembly 1 in one direction (e.g., the +X direction) is limited by the slider 1633 and the guide for the cable 118, as shown in FIG. 15, and a movement distance of the connector assembly 1 in the other direction (e.g., the −X direction) may be limited by the hook lance 1632 and the hook protrusion for the cable 117, as shown in FIG. 13.

For example, the guide for the cable 118, as shown in FIGS. 14-15, may be positioned on both sides of the slider 1633 in a direction perpendicular to the direction in which the slider 1633 slides, as shown in FIG. 14, thereby limiting the movement of the slider 1633 so that the slider 1633 may only move in one direction (e.g., the X direction). According to such a structure, the problem of the cable assembly 16 rotating around the direction in which the cable assembly 16 is inserted (e.g., the X direction) may be reduced.

Through such configurations, in a state in which the connector assembly 1 is properly fastened to the counterpart device D, the cable terminal 162 of the cable assembly 16 may have a specific posture (or angle) at a specific position within the inner space of the counterpart device D, and as a result, the fastening stability and ease of a fastening task between the connector assembly 1 and the counterpart device D may be improved.

Although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents.

Therefore, other implementations, other embodiments, and/or equivalents of the claims are within the scope of the following claims.

1. A connector assembly inserted into a counterpart device, comprising:
an inner housing having a terminal hole and formed of a non-conductive material;
a shield housing having a height lower than a height of the inner housing, surrounding a side surface of the inner housing, and formed of a conductive material;
an outer housing having an outer flange and an outer body, the outer body has a height lower than the height of the shield housing so that at least a portion of the shield housing is exposed to an outside and surrounding a side surface of the shield housing, the outer flange extends outward from the outer body; and
a connector seal disposed on an opposite side of the outer body and surrounding the side surface of the inner housing.

2. The connector assembly of claim 1, wherein in a state where the connector assembly is properly fastened to the counterpart device, one surface of the outer flange is in surface contact with a surface of the counterpart device, and a space between an inner wall of the counterpart device and an outer wall of the inner housing is sealed by the connector seal.

3. The connector assembly of claim 1, wherein the inner housing has an inner body through which the terminal hole is formed, and a seal stopper that protrudes outward from the inner body and limits a position at which the connector seal is inserted into the inner housing.

4. The connector assembly of claim 1, wherein the inner housing has an inner body through which the terminal hole is formed, and a shield stopper that protrudes outward from the inner body and supports one side of two sides of the shield housing, the connector seal is positioned on an other side of the two sides of the shield housing.

5. The connector assembly of claim 4, further comprising a seal retainer that is positioned on an opposite side of the shield housing so that the connector seal is not removed from the inner housing.

6. The connector assembly of claim 4, wherein, in a space between the shield stopper and the outer body, at least a portion of the shield housing is exposed to the outside.

7. The connector assembly of claim 1, wherein the shield housing has a shield body surrounding the side surface of the inner housing, and a fixing protrusion for the outer housing that fixes the outer body to a specific position on the shield body so that at least a portion of the shield body is exposed to the outside.

8. The connector assembly of claim 7, wherein the outer housing further has a fixing groove for shield that is recessed on an inner surface of the outer body, the fixing groove for shield engages with the fixing protrusion for the outer housing.

9. The connector assembly of claim 8, wherein the fixing groove for shield has a spacing-maintaining groove formed to extend in a height direction of the outer body from an end portion positioned on an opposite side of the connector seal.

10. The connector assembly of claim 9, wherein the fixing protrusion for the outer housing has a spacing-maintaining protrusion that protrudes inclined from a side surface of the shield body toward the connector seal, the spacing-maintaining protrusion engages with the spacing-maintaining groove.

11. The connector assembly of claim 8, wherein the fixing groove for shield has a removal prevention groove formed to extend in a height direction of the outer body from an end portion positioned adjacent to the connector seal.

12. The connector assembly of claim 11, wherein the fixing protrusion for the outer housing has a removal prevention protrusion that protrudes inclined from a side surface of the shield body toward an opposite side of the connector seal, the removal prevention protrusion engages with the removal prevention groove.

13. The connector assembly of claim 1, wherein the shield housing has a shield body surrounding the side surface of the inner housing, and a support protrusion for the inner housing protruding inward from the shield body to support the side surface of the inner housing.

14. The connector assembly of claim 1, wherein the shield housing has a shield body and a support protrusion for the device, the shield body has a ground part exposed to the outside in a state in which the connector assembly is inserted into the counterpart device, a coupling part formed with a structure that engages with the outer housing, and an insertion part inserted into the counterpart device, the support protrusion for the device is formed to protrude from the insertion part to elastically contact an inner surface of the counterpart device.

15. The connector assembly of claim 14, wherein the support protrusion for the device is positioned between the connector seal and the outer flange.

16. The connector assembly of claim 1, further comprising a cable assembly inserted into the terminal hole.

17. The connector assembly of claim 16, wherein the cable assembly has a connecting cable having a conductive wire and transmitting a power or a signal, a cable terminal connected to an end portion of the connecting cable, and a cable support structure supporting the cable terminal from an inner wall of the terminal hole.

18. The connector assembly of claim 17, wherein the inner housing has a portion formed to protrude from the inner wall of the terminal hole so that the cable support structure does not move or rotate within the terminal hole.

19. The connector assembly of claim 1, wherein the outer housing is formed of a non-conductive material.
